(19) United States
(12) Patent Application Publication
(10) Pub. No.: US 2005/0226560 A1
(43) Pub. Date: Oct. 13, 2005

(54) Apparatus for manufacturing chiral fiber bragg gratings

(76) Inventors: Victor Il'ich Kopp, Flushing, NY (US); Azriel Zelig Genack, New York, NY (US); Daniel Neugroschl, Suffern, NY (US); Jonathan Singer, Summit, NJ (US)

Correspondence Address: Edward Etkin, Esq.;Suite 3C, 4804 Bedford Avenue, Brooklyn, NY, 11235, US

(21) Appl. No.: 11/143,352

(22) Filed: Jun. 2, 2005

Related U.S. Application Data
(63) Continuation of application No. 10/020,678, filed on Dec. 12, 2001, now abandoned.
(60) Provisional application No. 60/254,816, filed on Dec. 12, 2000.

(51) Int. Cl. G02B 6/34

(52) U.S. Cl. 385/37

(57) ABSTRACT

An apparatus is disclosed for manufacturing chiral fibers having chiral fiber Bragg gratings properties from UV sensitive optical fibers, by using a UV laser beam to impose a chiral modulation of the refractive index at the core of the fiber.

### CROSS REFERENCE TO RELATED APPLICATIONS

This application is a continuation application of (and claims priority from) the commonly assigned co-pending U.S. patent application Ser. No. 10/020,678 entitled “Apparatus and Method for Manufacturing Chiral Fiber Bragg Gratings” which was filed on Dec. 12, 2001, which in turn claims priority from the commonly assigned U.S. provisional patent application Ser. No. 60/254,816 entitled “Apparatus and Method for Manufacturing Helical Fiber Bragg Gratings” filed on Dec. 12, 2000.

### FIELD OF THE INVENTION

The present invention relates generally to Bragg grating type structures, and more particularly to the manufacture of chiral fibers having chiral fiber Bragg grating properties.

### BACKGROUND OF THE INVENTION

Fiber Bragg gratings have many industrial applications—for example in information processing, in telecommunication systems, and especially in optical fiber communication systems utilizing wavelength division multiplexing (WDM). However, such devices are often difficult and/or expensive to manufacture.

The conventional method of manufacturing fiber Bragg gratings is based on photo-induced changes of the refractive index. One approach requires fine alignment of two interfering laser beams along the length of the optical fiber. Extended lengths of periodic fiber are produced by moving the fiber and re-exposing it to the interfering illumination while carefully aligning the interference pattern to be in phase with the previously written periodic modulation. The fiber core utilized in the process must be composed of specially prepared photorefractive glass, such as germanium doped silicate glass. This approach limits the length of the resulting grating and also limits the index contrast produced. Furthermore, such equipment requires perfect alignment of the interfering lasers and exact coordination of the fiber over minute distances when it is displaced prior to being exposed again to the laser interference pattern.

Another approach to fabricating fiber Bragg gratings involves the use of a long phase mask placed in a fixed position relative to a fiber workpiece before it is exposed to the UV beam. This approach requires photosensitive glass fibers and also requires manufacture of a specific mask for each type of fiber Bragg grating produced. Furthermore, the length of the produced fiber is limited by the length of the mask unless the fiber is displaced and re-aligned with great precision. This restricts the production of fiber Bragg gratings to relatively small lengths making the manufacturing process more time consuming and expensive.

One novel approach that addressed the problems in fabrication techniques of previously known fiber Bragg gratings is disclosed in the commonly-assigned co-pending U.S. patent application entitled “Apparatus and Method for Manufacturing Periodic Grating Optical Fibers”. This approach involved twisting heated optical preform (comprising either a single fiber or multiple adjacent fibers) to form a chiral structure having chiral fiber Bragg grating properties. Another novel approach for fabricating chiral fibers having chiral fiber Bragg grating properties, disclosed in the commonly-assigned co-pending U.S. provisional patent application entitled “Apparatus and Method for Fabricating Helical Fiber Bragg Gratings”, involved heating and twisting optical fibers having various core cross-section configurations or composed of different dielectric materials, inscribing patterns on the outer surface of the fiber cores, and optionally filling the patterns with dielectric materials.

While the techniques described in the above patent applications have many advantages over previously known approaches, they require specially prepared fiber preforms—for example fibers with pre-configured core cross-section shapes and in some cases specific relationships between refractive indices of the preform fiber core and cladding. Thus, in order to fabricate a chiral fiber having a desired refractive index profile, a preform fiber with specific characteristics would need to be prepared prior to fabrication of the chiral fiber.

It would thus be desirable to provide a manufacturing apparatus and method for easily, cheaply and accurately producing an optical fiber with a periodic (i.e. Bragg) grating. It would also be desirable to provide a method for configuring the inventive apparatus to produce optical fibers with a variety of refractive index profiles for different applications from a standard UV-sensitive fiber. It would further be desirable to provide an apparatus and method for manufacturing periodic grating fibers of lengths greater than can be produced with acceptable quality utilizing previously known techniques.

### BRIEF DESCRIPTION OF THE DRAWINGS

FIG. 1A is a schematic diagram of a first embodiment of the inventive apparatus for manufacturing fiber Bragg gratings;

FIG. 1B is a schematic diagram of a second embodiment of the inventive apparatus for manufacturing fiber Bragg gratings;

FIG. 1C is a schematic diagram of a third embodiment of the inventive apparatus for manufacturing fiber Bragg gratings;

FIG. 2A is a side view of an optical fiber being converted into a fiber Bragg grating structure by the inventive apparatus of FIGS. 1A to 1C.

FIG. 2B is a cross-section view of an optical fiber being converted into a fiber Bragg grating structure by the inventive apparatus of FIGS. 1A to 1C.

FIG. 3A is a close-up schematic diagram of a first embodiment of optical components of the inventive apparatus for manufacturing fiber Bragg gratings of FIGS. 1A to 1C;

FIG. 3B is a close-up schematic diagram of a second embodiment of optical components of the inventive apparatus for manufacturing fiber Bragg gratings of FIGS. 1A to 1C;

FIG. 3C is a close-up schematic diagram of a third embodiment of optical components of the inventive apparatus for manufacturing fiber Bragg gratings of FIGS. 1A to 1C;

FIG. 3D is a close-up schematic diagram of a fourth embodiment of optical components of the inventive apparatus for manufacturing fiber Bragg gratings of FIGS. 1A to 1C; and

FIG. 3E is a close-up schematic diagram of a fifth embodiment of optical components of the inventive apparatus for manufacturing fiber Bragg gratings of FIGS. 1A to 1C.

### SUMMARY OF THE INVENTION

The present invention is directed to an apparatus and method for manufacturing fiber Bragg gratings from normal optical fibers by imposing a chiral modulation of the refractive index at the core of the fiber. In summary, a UV-sensitive optical fiber is retained at both ends, tensioned, and then rotated about its longitudinal axis while one or more UV laser beams is focused on a portion of the optical fiber core as the optical fiber is moved relative to the UV beam(s). Different embodiments of the present invention demonstrate various advantageous techniques for providing relative motion of the optical fiber and the UV beam. Depending on the configuration and position of the UV beam with respect to the optical fiber, chiral fibers with various refractive index profiles may be readily produced. For example, chiral fibers with either helical or double helical refractive index modulation may be fabricated in accordance with the present invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF THE PREFERRED EMBODIMENTS

The present invention is directed to an apparatus for manufacturing chiral fibers (having chiral fiber Bragg grating properties) from UV-sensitive optical fibers by imposing a chiral modulation of the refractive index at the core of the fiber. The inventive apparatus relies on the fact that the refractive index of a UV-sensitive fiber is changed by exposure to a UV beam, where the particular refractive index profile of the resulting optical fiber is dependent on the configuration and position of the UV beam. It should be understood to one skilled in the art that one or more control units for controlling operation of the various components of the inventive apparatus may be readily utilized without departing from the spirit of the invention.

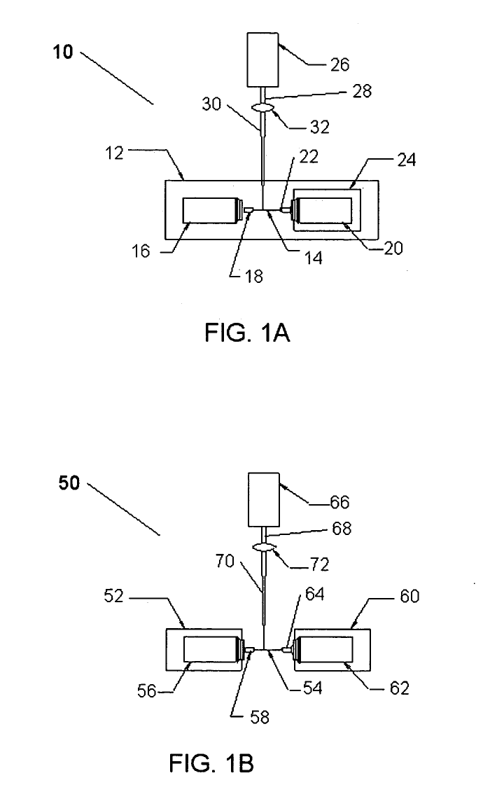

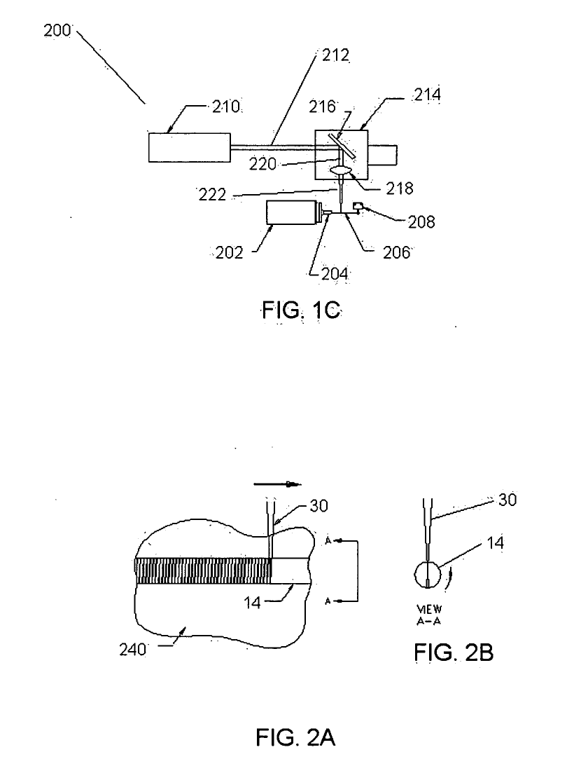

Referring now to FIG. 1A, a first embodiment of the inventive chiral fiber manufacturing apparatus 10 is shown. The apparatus 10 includes a UV laser 26, a rotary unit 16 having a fiber retaining mechanism 18 (for example, a chuck), and a rotary unit 20 having a fiber retaining mechanism 22. The apparatus 10 also includes a focusing unit 32 (such as a lens) for focusing a UV laser beam 28 into a focused UV beam 30. While the UV laser 26 is shown as delivering the UV laser beam 28 directly to the focusing unit 32, as a matter of design choice, the UV beam 28 may be reflected by one or more mirrors (not shown) into the focusing unit 32. This arrangement would be useful if the UV laser 26 is remotely positioned.

A UV-sensitive optical fiber 14 is held at each end between the rotary units 16, 20 by respective retaining mechanisms 18, 22 and positioned such that it is exposed to the focused UV beam 30. The optical fiber 14 is then tensioned by a tensioning mechanism 24 connected to the rotary unit 20. The rotary units 16, 20 are configured to rotate the fiber 14 about its longitudinal axis at a predetermined rotating speed. The rotary units 16, 20 and the tensioning mechanism 24 are mounted on a linear translation stage 12 capable of moving the rotary units 16, 20 (and thus the fiber 14) along a linear path at a predetermined linear speed while maintaining exposure of the fiber 14 to the focused UV beam 30.

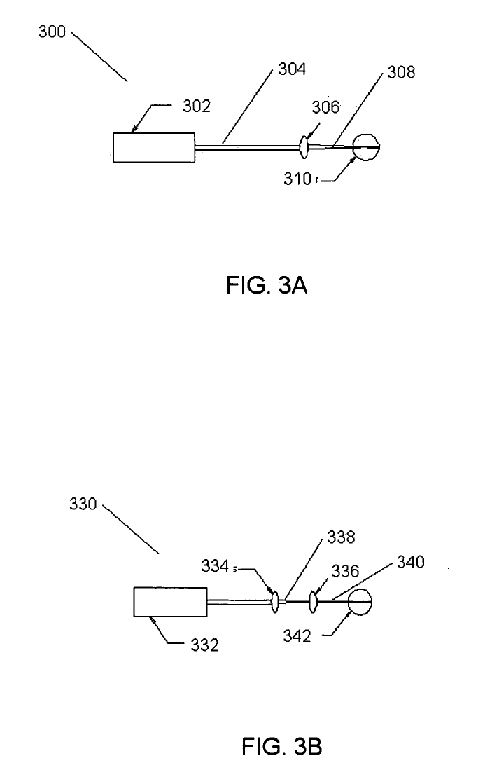

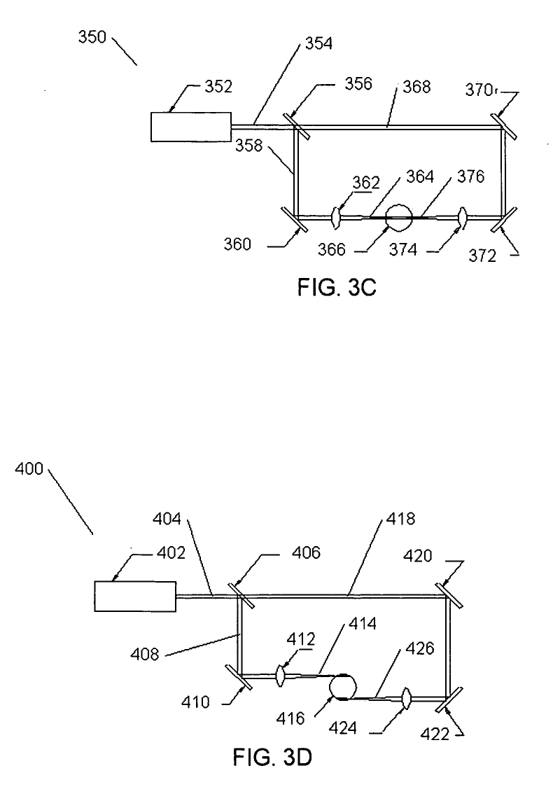

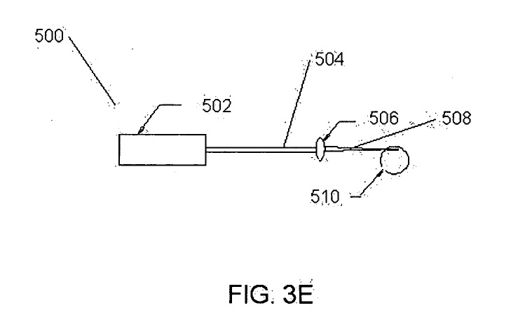

The inventive fabrication process begins by positioning the linear translation stage 12 in such a way as to align the first portion of the fiber 14 (near the retaining mechanism 18) with the focused UV beam 30. The rotary units 16, 20 then rotate the fiber 14 at a predetermined rotation speed while the linear stage 12 moves the fiber 14 at a predetermined linear speed while maintaining exposure to the focused UV beam 30 until the focused UV beam 30 is substantially near the retaining mechanism 22. The predetermined rotation and linear speeds are selected as a matter of design choice depending on the specific construction of the various components of the apparatus 10 without departing from the spirit of the invention. By exposing the moving and rotating fiber 14 to the focused UV beam 30, the refractive index of the fiber 14 is modulated along its length. As a result, the fiber 14 becomes a chiral fiber having chiral fiber Bragg grating properties. Close-up side and cross-section views of the above-described process are shown in FIGS. 2A and 2B, respectively. FIG. 2A shows the fiber 14 with a core 240 moving forward and rotating around its axis as the focused UV beam 30 modulates its refractive index. FIG. 2B shows the focused UV beam 30 directed to a center of the fiber 14, which would produce double helix chiral modulation (see FIG. 3A).

The specific refractive index profile of the fiber 14 (for example, whether the chiral modulation is helical or double helical) depends on the specific configuration and positioning of the focused UV beam 30. Various inventive embodiments of configuring focused UV beams to produce a variety of refractive index profiles in optical fibers are discussed in greater detail below in connection with FIGS. 3A to 3E.

Referring now to FIG. 1B, a second embodiment of the inventive chiral fiber manufacturing apparatus 50 is shown. The apparatus 66 includes a UV laser 66, a rotary unit 66 having a fiber retaining mechanism 68 (for example, a chuck), and a rotary unit 62 having a fiber retaining mechanism 64. The apparatus 50 also includes a focusing unit 72 (such as a lens) for focusing a UV laser beam 68 into a focused UV beam 70. While the UV laser 66 is shown as delivering the UV laser beam 68 directly to the focusing unit 72, as a matter of design choice, the UV beam 68 may be reflected by one or more mirrors (not shown) into the focusing unit 72. This arrangement would be useful if the UV laser 66 is remotely positioned.

A UV-sensitive optical fiber 54 is held at each end between the rotary units 56, 62 by respective retaining mechanisms 58, 64 and positioned such that it is exposed to the focused UV beam 70. The rotary units 56, 62 are configured to rotate the fiber 54 about its longitudinal axis at a predetermined rotating speed. The rotary unit 56 is mounted on a linear translation stage 52 while the rotary unit 62 is mounted on a separate linear translation stage 60. The linear translation stages 52, 60 are preferably aligned and capable of moving the rotary units 56, 62 (and thus the fiber 54) along a linear path at a predetermined linear speed while maintaining exposure of the fiber 54 to the focused UV beam 70. By varying the speed of the linear translation stage 60, the fiber 54 may be readily tensioned.

The inventive fabrication process begins by positioning the linear translation stages 52, 60 in such a way as to align the first portion of the fiber 54 (near the retaining mechanism 58) with the focused UV beam 70. The fiber 54 is then tensioned by slightly moving the linear stage 60. The rotary units 56, 62 then rotate the fiber 54 at a predetermined rotation speed while the linear stages 52, 60 move the fiber 54 at a predetermined linear speed while maintaining exposure to the focused UV beam 70 (and tension in the fiber 54) until the focused UV beam 70 is substantially near the retaining mechanism 64. The predetermined rotation and linear speeds are selected as a matter of design choice depending on the specific construction of the various components of the apparatus 50 without departing from the spirit of the invention. By exposing the moving and rotating fiber 54 to the focused UV beam 70, the refractive index of the fiber 54 is modulated along its length. As a result, the fiber 54 becomes a chiral fiber having chiral fiber Bragg grating properties. The specific refractive index profile of the fiber 54 (for example, whether the chiral modulation is helical or double helical) depends on the specific configuration and positioning of the focused UV beam 70. Various inventive embodiments of configuring focused UV beams to produce a variety of refractive index profiles in optical fibers are discussed in greater detail below in connection with FIGS. 3A to 3E.

Referring now to FIG. 1C, a third embodiment of the inventive chiral fiber manufacturing apparatus 200 is shown. The apparatus 200 includes a UV laser 210 and a reflecting unit 216 (such as a mirror) for reflecting a UV laser beam 212 into a focusing unit 218 (such as a lens). The focusing unit 218 focuses a reflected UV laser beam 220 into a focused UV beam 222. The apparatus 200 also includes a rotary unit 202 having a fiber retaining mechanism 204 (for example, a chuck), and a fiber support 208 for retaining and tensioning a UV-sensitive fiber 206 held at each of its ends by the respective retaining mechanism 204 and the fiber support 208, while allowing it to freely rotate. The rotary unit 202 is configured to rotate the fiber 206 about its longitudinal axis at a predetermined rotating speed. The fiber 206 is also positioned such that it is exposed to the focused UV beam 222.

The reflecting unit 216 and the focusing unit 218 are mounted on a linear translation stage 214 capable of moving the reflecting unit 216 and the focusing unit 218 along a linear path at a predetermined linear speed while maintaining exposure of the fiber 206 to the focused UV beam 222.

The inventive fabrication process begins by positioning the linear translation stage 214 in such a way as to align the first portion of the fiber 206 (near the retaining mechanism 204) with the focused UV beam 222. The rotary unit 202 then rotates the fiber 206 at a predetermined rotation speed while the linear stage 214 moves the focused UV beam 222 at a predetermined linear along the rotating fiber 206 until the focused UV beam 22 is substantially near the fiber support 208. The predetermined rotation and linear speeds are selected as a matter of design choice depending on the specific construction of the various components of the apparatus 200 without departing from the spirit of the invention. By exposing the rotating fiber 206 to the moving focused UV beam 222, the refractive index of the fiber 206 is modulated along its length. As a result, the fiber 206 becomes a chiral fiber having chiral fiber Bragg grating properties.

The specific refractive index profile of the fiber 206 (for example, whether the chiral modulation is helical or double helical) depends on the specific configuration and positioning of the focused UV beam 222. Various inventive embodiments of configuring focused UV beams to produce a variety of refractive index profiles in optical fibers are discussed in greater detail below in connection with FIGS. 3A to 3E.

One of the primary advantages of the inventive apparatus is its capability to fabricate chiral optical fibers having refractive index profiles customized for particular applications. For example, a chiral laser such as the one disclosed in a co-pending commonly assigned U.S. provisional patent application entitled “Chiral Laser Apparatus and Method”, requires a chiral fiber with double helix chiral modulation, while chiral fibers used in an add-drop filter, such as one disclosed in a co-pending commonly assigned U.S. patent application entitled “Add-drop Filter Utilizing Chiral Elements” should preferably have single helix chiral modulation. Furthermore, structures having double or single helix chiral modulation with different or custom refractive index profiles may be desirable for specific applications.

In accordance with the present invention, the type of chiral modulation (single or double helix) and the specific refractive index profile of the fabricated chiral optical fiber may be configured by varying the position and/or number of UV laser beams focused into the UV-sensitive fiber. Referring now to FIGS. 3A to 3E, several exemplary optical component configurations for fabricating customized optical fibers are shown. These optical component embodiments may be readily and advantageously utilized with the various embodiments of the inventive apparatus shown in FIGS. 1A to 1C.

Referring now to FIG. 3A, an optical component 300 is shown. The optical component 300 includes a UV laser 302 for delivering a UV laser beam 304 to a focusing device 306 (such as a lens) for focusing the UV laser beam 304 to a focused UV beam 308. The focused UV beam 308 is directed into a center of a UV-sensitive fiber 310 while the fiber 310 is rotated and moved relative to the focused UV beam 308. The optical component 300 thus produces a fiber having a double helix chiral modulation.

Referring now to FIG. 3B, an optical component 330 is shown. The optical component 330 includes a UV laser 332 for delivering a UV laser beam to a first focusing device 336 (such as a lens) for focusing the UV laser beam to a focused UV beam 338. The focused UV beam 338 is directed to a second focusing device 336 for collimating the focused UV beam 338 into a collimated UV beam 340. The collimated UV beam 340 is directed into the center of a UV-sensitive fiber 342 while the fiber 342 is rotated and moved relative to the collimated UV beam 340. The optical component 330 thus produces a fiber having a double helix chiral modulation.

Referring now to FIG. 3C, an optical component 350 is shown. The optical component 350 includes a UV laser 352 for delivering a UV laser beam 354 to a first reflecting device 356 (such as a mirror) and to a second reflecting device 370, as a UV laser beam 368. The first reflecting device 356 reflects the UV laser beam 354 as a reflected UV laser beam 358 to a third reflecting device 360 that further reflects the beam 358 to a first focusing device 362 (such as a lens) for focusing the beam 358 to a focused UV beam 364. Similarly, the second reflecting device 370 reflects the UV laser beam 368 to a fourth reflecting device 372 that further reflects the beam 368 to a second focusing device 374 (such as a lens) for focusing the beam 368 to a focused UV beam 376.

Preferably, the third and fourth reflecting devices 360, 372 are aligned exactly opposite one another such that the focused UV beams 364, 376 are then directed into a center of a UV-sensitive fiber 366 from opposite directions while that fiber 366 is rotated and moved relative to the focused UV beams 364, 376. The optical component 350 thus produces a fiber having a double helix chiral modulation.

Referring now to FIG. 3D, an optical component 400 is shown. The optical component 400 includes a UV laser 402 for delivering a UV laser beam 404 to a first reflecting device 406 (such as a mirror) and to a second reflecting device 420, as a UV laser beam 418. The first reflecting device 406 reflects the UV laser beam 404 as a reflected UV laser beam 408 to a third reflecting device 410 that further reflects the beam 408 to a first focusing device 412 (such as a lens) for focusing the beam 408 to a focused UV beam 414. Similarly, the second reflecting device 420 reflects the UV laser beam 418 to a fourth reflecting device 422 that further reflects the beam 418 to a second focusing device 424 (such as a lens) for focusing the beam 418 to a focused UV beam 426.

Preferably, the third and fourth reflecting devices 410, 422 are aligned opposite and vertically displaced from one another such that the focused UV beam 414 is directed to an upper outer surface of a UV-sensitive fiber 416 while the focused UV beam 426 is directed to a lower outer surface of the fiber 416, while the fiber 416 is rotated and moved relative to the focused UV beams 414, 426. The optical component 400 thus produces a fiber having a double helix chiral modulation. It should be noted that the exact positions of the various reflecting devices (and thus the focused UV beams) may be selected and changed as a matter of design choice without departing from the spirit of the invention as long as each of the two focused UV beams are parallel to one another, perpendicular to the fiber's longitudinal axis, and directed to opposing outer surfaces of the optical fiber.

Referring now to FIG. 3E, an optical component 500 is shown. The optical component 500 includes a UV laser 502 for delivering a UV laser beam 504 to a focusing device 306 (such as a lens) for focusing the UV laser beam 504 to a focused UV beam 508. The focused UV beam 508 is directed parallel to an outer surface of a UV-sensitive fiber 510 and perpendicular to its longitudinal axis, while the fiber 510 is rotated and moved relative to the focused UV beam 508. The optical component 500 thus produces a fiber having a single helix chiral modulation.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

1. An apparatus for manufacturing a chiral fiber having a desired chiral refractive index modulation, from a UV-sensitive optical fiber of a predefined refractive index and having a core and a longitudinal axis, the apparatus comprising:
optical fiber retaining means for retaining the optical fiber in a substantially tensioned state along the longitudinal axis;
an optical fiber rotating assembly, connected to at least a portion of said optical fiber retaining means, operable to rotate the optical fiber about its longitudinal axis at a predetermined rotation speed, while enabling said optical fiber retaining means to maintain said substantially tensioned state;
a UV radiation device operable to generate a UV radiation beam configured to alter the predefined refractive index of a portion of the optical fiber core in a predetermined manner, when said portion of the optical fiber core is exposed thereto; and
UV exposure assembly, positioned proximal to said optical fiber retaining means and to said optical fiber rotating assembly, operable to selectively impose the desired chiral refractive index modulation over a predefined length of the optical fiber, by selectively exposing a plurality of sequential portions of the optical fiber core along the longitudinal axis thereof, to said UV radiation beam, during operation of said fiber rotating assembly, thereby manufacturing the chiral fiber.

2. The chiral fiber manufacturing apparatus of claim 1, wherein the optical fiber comprises a first end and a second end, wherein:
said optical fiber retaining means comprise a first holding device operable to retain said first end of the optical fiber, and a second holding device operable to retain said second end of the optical fiber; and wherein:
said optical fiber rotating assembly comprises a first rotation unit connected to said first holding device, and a second rotation unit connected to said second holding device.

3. The chiral fiber manufacturing apparatus of claim 1, wherein said UV radiation device is stationary, and wherein said UV exposure assembly comprises a translation stage, wherein said optical fiber retaining means and said optical fiber rotating assembly are positioned on said translation stage, and wherein said translation stage is operable to move the optical fiber along its longitudinal axis, during rotation thereof by said optical fiber rotating assembly, while exposing said sequential plural portions of the optical fiber to said UV radiation beam.

4. The chiral fiber manufacturing apparatus of claim 3, wherein the optical fiber comprises a first end and a second end, wherein:
said optical fiber retaining means comprise a first holding device operable to retaining said first end of the optical fiber, and a second holding device operable to retaining said second end of the optical fiber;
said optical fiber rotating assembly comprises a first rotation unit connected to said first holding device, and a second rotation unit connected to said second holding device;
said translation stage comprises a first linear translation stage and an second linear translation stage, operable to move independently from said first linear translation stage; and wherein:
said first rotation unit is connected to said first linear translation stage, and said second rotation unit is connected to said second linear translation stage.

5. The chiral fiber manufacturing apparatus of claim 4 wherein the said first and said second linear translation stages are operable to move at different speeds to maintain tension in the optical fiber during operation of said UV exposure assembly.

6. The chiral fiber manufacturing apparatus of claim 1, wherein said UV radiation device comprises:
a UV laser operable to emit a UV beam; and
a first focusing unit operable to focus said UV radiation beam into a focused UV radiation beam.

7. The chiral fiber manufacturing apparatus of claim 6, wherein said UV radiation device further comprises at least one reflecting device, positioned between said UV laser and said first focusing unit, operable to reflect said UV beam into said first focusing unit.

8. The chiral fiber manufacturing apparatus of claim 6, wherein said first focusing unit comprises at least one focusing lens.

9. The chiral fiber manufacturing apparatus of claim 1, wherein said UV exposure assembly comprises a translation stage, wherein said UV radiation device is positioned on said translation stage, and wherein said translation stage is operable to move said UV radiation device along the longitudinal axis of the optical fiber, during rotation thereof by said optical fiber rotating assembly, thereby exposing said sequential plural portions of the optical fiber to said UV radiation beam.

10. The chiral fiber manufacturing apparatus of claim 1, wherein the optical fiber comprises a first end and a second end, wherein said optical fiber retaining means comprise a retaining device operable to retain said first end of the optical fiber, and a support device operable to retain said second end of the optical fiber while enabling free rotation thereof about the longitudinal axis, and wherein said optical fiber rotating assembly comprises a rotation unit connected to said retaining device.

11. The chiral fiber manufacturing apparatus of claim 1, wherein said desired chiral refractive index modulation is one of: a single helix modulation, or, a double helix modulation.

12. The chiral fiber manufacturing apparatus of claim 6, wherein said UV radiation device further comprises a first UV beam directing assembly, operable to direct said focused UV beam, during operation of said UV exposure assembly, into at least one predefined region of the optical fiber core.

13. The chiral fiber manufacturing apparatus of claim 12, wherein said first UV beam directing assembly comprises at least one mirror.

14. The chiral fiber manufacturing apparatus of claim 12, wherein said at least one predefined region of the optical fiber core comprises a longitudinal central region, and wherein said first UV beam directing assembly is further operable to direct said focused UV beam into said central region of the optical fiber core, in a direction perpendicular to the optical fiber longitudinal axis, to thereby produce a double helix chiral modulation in the optical fiber.

15. The chiral fiber manufacturing apparatus of claim 12, wherein said at least one predefined region of the optical fiber core comprises an outer region, and wherein said first UV beam directing assembly is further operable to direct said focused UV beam into said outer region of the optical fiber core, in a direction perpendicular to the optical fiber longitudinal axis, to thereby produce a single helix chiral modulation in the optical fiber.

16. The chiral fiber manufacturing apparatus of claim 12, further comprising:
a second focusing unit, positioned between said first focusing unit and said first UV beam directing assembly, operable to produce a collimated UV beam from said focused UV beam;
wherein said at least one predefined region of the optical fiber core comprises a longitudinal central region, and wherein said first UV beam directing assembly is further operable to direct said collimated UV beam into said central region of the optical fiber core, in a direction perpendicular to the optical fiber longitudinal axis, to thereby produce a double helix chiral modulation in the optical fiber.

17. The chiral fiber manufacturing apparatus of claim 12, further comprising:
a second UV beam directing assembly, positioned facing directly opposite to, and aligned with said first UV beam directing assembly, such that the optical fiber core is positioned therebetween;
a UV beam splitting unit, positioned sequentially to said first focusing unit, operable to produce a first additional focused UV beam from said focused UV beam and to deliver said focused UV beam to said first UV beam directing assembly, and said first additional focused UV beam to said second UV beam directing assembly;
wherein said at least one predefined region of the optical fiber core comprises a longitudinal central region, and wherein said first UV beam directing assembly is further operable to direct said focused UV beam into said central region of the optical fiber core, in a direction perpendicular to the optical fiber longitudinal axis, and wherein said second UV directing assembly is operable to direct said first additional focused UV beam into said central region of the optical fiber core, in a direction opposite from said focused UV beam, but also perpendicular to the optical fiber longitudinal axis, to thereby produce a double helix chiral modulation in the optical fiber.

18. The chiral fiber manufacturing apparatus of claim 17, wherein said second UV beam directing assembly comprises at least one mirror.

19. The chiral fiber manufacturing apparatus of claim 17, wherein said UV beam splitting unit comprises at least one mirror.

20. The chiral fiber manufacturing apparatus of claim 12, further comprising:
a third UV beam directing assembly, positioned facing opposite to, and offset from said first UV beam directing assembly by a predetermined offset distance, such that the optical fiber core is positioned therebetween;
a second UV beam splitting unit, positioned sequentially to said first focusing unit, operable to produce a second additional focused UV beam from said focused UV beam and to deliver said focused UV beam to said first UV beam directing assembly, and said second additional focused UV beam to said third UV beam directing assembly;
wherein said at least one predefined region of the optical fiber core comprises a first outer region and a second outer region, and wherein said first UV beam directing assembly is further operable to direct said focused UV beam into said first outer region of the optical fiber core, in a direction perpendicular to the optical fiber longitudinal axis, and wherein said third UV directing assembly is operable to direct said second additional focused UV beam into said second outer region of the optical fiber core, in a direction opposite from said focused UV beam, but also perpendicular to the optical fiber longitudinal axis, to thereby produce a double helix chiral modulation in the optical fiber.

21. The chiral fiber manufacturing apparatus of claim 20, wherein said third UV beam directing assembly comprises at least one mirror.

22. The chiral fiber manufacturing apparatus of claim 20, wherein said second UV beam splitting unit comprises at least one mirror.
